(19) United States
(12) Patent Application Publication
(10) Pub. No.: US 2008/0300324 A1
(43) Pub. Date: Dec. 4, 2008

(54) Composition for solidifying solid fossil fuels

(76) Inventor: Kap Sok Yi, Bogota, NJ (US)

Correspondence Address: REED SMITH LLP, Suite 1400, 3110 Fairview Park Drive, Falls Church, VA, 22042, US

(21) Appl. No.: 11/819,476

(22) Filed: Jun. 27, 2007

(30) Foreign Application Priority Data
Jun. 1, 2007 (KR) 10-2007-0053878

(51) Int. Cl. B01F 3/08

(52) U.S. Cl. 516/38

(57) ABSTRACT

Disclosed herein is a solidifying composition, which is added to a single solid fossil fuel or a mixture thereof to solidify the solid fossil fuels. The solidifying composition contains 34-52 wt % of straight asphalt, 0.1-0.3 wt % of an emulsifier for asphalt, 0.2-0.4 wt % of hydrochloric acid, 0.03-0.05 wt % of calcium chloride, and the balance of water. When this solidifying composition is used, a single solid fossil fuel or mixture thereof, including bituminous coal, anthracite coal and powdery coke, can be used as a raw material for coke. Also, even when the prior coke equipment, incurring a high equipment cost, is not used, it is possible to prepare coke, which can maintain the durability and high-temperature stability of coke prepared using the prior coking coal as a main raw material and which has a high heating value.

### BACKGROUND OF THE INVENTION

1. Field of the Invention

The present invention relates to a composition for solidifying solid fossil fuels, and more particularly a composition for solidifying solid fossil fuels, which contains straight asphalt as a main component and is added to a single solid fossil fuel or mixture thereof, including bituminous coal, powdery coke, generated during a shaping process, and anthracite coal, to solidify the solid fossil fuels.

2. Description of the Prior Art

In a prior process for manufacturing molten iron, which is used as the basic raw material of steel (hereinafter, referred to as a “furnace process”), a blast furnace is used, and iron ore and coal are used in the blast furnace. However, to spread heat evenly to increase the production rate of molten iron, iron ore has been used as sintered ore in the form of a mass having a given size, prepared through a sintering process, and coal has been used as coke in the form of a mass, prepared through a coke process. However, to carry out such a coke process, a separate coke furnace and a gas system for heating the coke furnace are required, and thus a high equipment cost is incurred and a large amount of environmental pollutants are emitted from such equipment. Also, it is not acceptable to extinguish the furnace fire in order to save production cost, and a lot of time is required for the sintering process and the coke process. In addition, iron ore, which can be used in the sintering process, is limited to expensive mass iron ore, which increases the production cost. Also, coal, which can be used in the coke process, is limited to coking coal, which depends completely on imports and causes the outflow of a large amount of foreign currency, or a mixture containing at least 50-60% coking coal, because the coking coal has high heating value. Moreover, powdery coke, which is generated as a byproduct during the coke process in an amount of about 3-8%, is not easy to reuse in a steel manufacturing process.

In an attempt to solve these problems of the prior furnace process, POSCO Co., Korea, developed a new process. According to the new process, powdery iron ore, the price of which is 23% less than that of massive iron ore used in the furnace process or lower, is used as the raw material of sintered ore, and general bituminous coal, the price of which is 20% less than that of coking coal or lower, is used as the raw material of coke, and thus the new process has an effect of decreasing production cost by 10-15% compared to the furnace process. This process comprises converting reduced powdery iron ore to sintered ore using an HCI (hot compacted iron) manufacturing system, forming general bituminous coal into coke, and introducing the ore and the coke into a blast furnace to extract molten iron. Unlike the prior furnace process, in the new process, it is possible to extinguish the furnace fire according to the market and operation time. Thus, the new process allows production to be freely controlled and has an effect of decreasing production costs by about 8%. However, coal, which can be used in the process, is still limited to bituminous coal.

In addition, in order to prepare coke using coking coal without carrying out the prior coke process requiring expensive equipment, methods of using materials of solidifying coking coal have been developed. For example, there is a method of using a mixture prepared by mixing petroleum-based pitch, potato starch and molasses in water. However, when this mixture is used as the solidifying agent, the high-temperature stability of the prepared coke is insufficient, and the price of the solidifying agent is also high. Thus, this mixture has been limitedly used in only some processes.

Coke is used for casting purposes and is also used in metallurgical processes for manufacturing iron alloys, lead and zinc, according to the size and strength thereof, or in furnaces for manufacturing lime and magnesia. Moreover, it is used in the preparation of calcium carbonate, the raw material of acetylene, and coke powder is used as industrial boiler fuel.

Considering the domestic circumstances, where bituminous coal used as the main raw material of coke depends entirely on imports, there has been an urgent demand for a method, which enables bituminous coal to be prepared into coke without generating byproducts such as powdery coke and allows other solid fossil fuels, such as anthracitic coal and powdery coke, which are domestically produced in large amounts, to be used as raw materials for preparing coke.

According to this demand, the present inventors filed a patent application relating to a composition for solidifying solid fossil fuels, comprising 25-35 wt % of emulsified asphalt, 0.05-0.20 wt % of an emulsifier for asphalt, 0.1-0.3 wt % of hydrochloric acid, 0.01-0.05 wt % of calcium chloride, 0.01-0.05 wt % of oleic acid, 0.005-0.030 wt % of a surfactant, and the balance of water (Korean Patent Application No. 2005-0068731, filed on Jul. 28, 2005). However, this composition has problems in that the production cost of the composition is somewhat high due to the use of emulsified asphalt, and the composition cannot sufficiently handle solid fossil fuels having high moisture content, and thus requires equipment and time for adjusting the moisture content of the solid fossil fuel to a suitable range.

### SUMMARY OF THE INVENTION

The present inventors have conducted many studies on a solidifying composition capable of solving the prior problems, using, as a main material, straight asphalt among various petroleum asphalts. As a result, the present inventors have found that when a solidifying composition according to the present invention is added to prepare solidified materials from solid fossil fuels, such as coke, a single solid fossil fuel or a mixture thereof, such as bituminous coal, anthracite coal or powdery coke, can be used as a raw material for coke, and at the same time, it is possible to prepare coke which can maintain the durability and high-temperature stability of coke prepared according to the prior furnace process using coking coal as a main raw material and has high heating value, thereby completing the present invention.

It is an object of the present invention to provide a composition for solidifying solid fossil fuels, which contains straight asphalt as a main raw material and can solidify all solid fossil fuels based on coal to prepare solidified materials from solid fossil fuels, such as coke.

To achieve the above object, the present invention provides a composition for solidifying solid fossil fuel, comprising 34-52 wt % of straight asphalt, 0.1-0.3 wt % of an emulsifier for asphalt, 0.2-0.4 wt % of hydrochloric acid, 0.03-0.05 wt % of calcium chloride, and the balance of water.

### DETAILED DESCRIPTION OF THE INVENTION

Hereinafter, the present invention will be described in further detail.

The inventive composition for solidifying solid fossil fuels contains, as essential elements, straight asphalt, an emulsifier for asphalt, hydrochloric acid, calcium chloride and water.

Generally, petroleum asphalts are obtained in processes for producing petroleum-based products, such as petroleum refining, and can be divided into straight asphalt, asphalt cement, cutback asphalt, emulsified asphalt, blown asphalt, modified asphalt and the like. Among them, the straight asphalt is the heaviest fraction contained in crude oil, and is residue obtained by completely removing light fractions by distillation in a high vacuum through a vacuum distillation system. It has high elongation and adhesion, and the softening point thereof is generally lower than 65° C. It is used mainly for road pavement and airport pavement. Such straight asphalt is commercially available under the trade names of AP-3, AP-5, etc. from asphalt production companies in Korea, and thus it can be used without any additional processing to reduce production cost. In the present invention, the straight asphalt serves to increase the elasticity and stability of mixed particles and waterproof surfaces. If it is contained in an amount of less than 34 wt %, the high-temperature stability of the composition will be insufficient due to a reduction in the elasticity between particles, and if it is contained in an amount of more than 52 wt %, the composition will easily burn or will reduce the porosity of fossil fuels. For this reason, the straight asphalt is contained in an amount of 34-52 wt % based on the total weight of the solidifying composition.

The emulsifier for asphalt has good degradability due to its high emulsifying ability, and is thus used to emulsify asphalt. As the emulsifier, any emulsifier can be used without any particular limitation as long as it is a cationic or non-ionic emulsifier. If it is contained in an amount of less than 0.1 wt %, it will not emulsify asphalt, and if it is contained in an amount of more than 0.3 wt %, it will enhance adhesion, but increase product costs. For this reason, the emulsifier is contained in an amount of 0.1-0.3 wt % based on the total weight of the solidifying composition.

Hydrochloric acid is mixed with the emulsifier for asphalt to perform dispersion and decomposition, and is used for mixing and purification. Also, due to the hydrogen ion (H⁺) of hydrochloric acid, the solidifying composition becomes cationic, making it possible to rapidly solidify solid fossil fuels. If it is contained in an amount of less than 0.2 wt %, it will not provide smooth dispersion and decomposition, and if it is contained in an amount of more than 0.4 wt %, it will cause an environmental problem. For this reason, hydrochloric acid is contained in an amount of 0.2-0.4 wt % based on the total weight of the solidifying composition. More preferably, it is contained in an amount of 0.30-0.35 wt %.

Calcium chloride functions to prevent freezing and is used to increase density so as to prevent cracks and promote absorption. If it is contained in an amount of less than 0.03 wt %, it will not sufficiently absorb moisture, and thus will has an insufficient effect on the prevention of freezing, and if is contained in an amount of 0.05 wt %, a large amount of anhydrides will be generated, making it difficult to maintain the solidifying composition in the liquid state. For this reason, it is contained in an amount of 0.03-0.05 wt % based on the total weight of the solidifying composition.

Water is contained to form the rest of the above-described components, and the contents thereof are adjusted according to the kind and wettability of product. If water is contained in an excessively small amount, emulsification and dispersion will not sufficiently occur, and the cost of the composition will increase, and if it is contained in an excess amount, it will reduce the adhesion between particles, waterproofing ability and strength of the composition. For this reason, the content of water should also be adjusted in a suitable range. Most preferably, it is contained in an amount of about 50-60 wt % based on the total weight of the solidifying composition.

In addition, to further increase the adhesion between particles, the composition may comprise an acrylic emulsion-based asphalt modifier in an amount of 1-3 wt % based on the total weight of the composition. Preferably, the modifier is a styrene-butadiene-styrene (SBS) block copolymer. For example, Butonal NS 198 (manufactured by BASF, USA) can be used.

The inventive solidifying composition containing the above-described components is added to solid fossil fuels to solidify the solid fossil fuels. As the solid fossil fuel, any fuel can be used without any particular restriction as long as it is coal or a coal-based fuel. Particularly, it is preferable to use powdery coke, bituminous coal, anthracitic coal, or a mixture of two or more thereof.

When a solidified material is prepared by adding the inventive solidifying composition to a single solid fossil fuel or mixture thereof, the solid fossil fuel as a raw material can be solidified regardless of the moisture content thereof, and it is possible to prepare a solidified material, which has excellent durability and high-temperature stability and a short curing time. Also, when the inventive solidifying composition, further comprising aqueous acrylic resin as a reinforcing agent, is used in the preparation of solidified materials, it is possible to prepare products having greatly improved adhesion, fine particle dispersion and waterproofing properties.

Hereinafter, the present invention will be described in further detail with reference to examples and comparative examples. It is to be understood, however, that these examples are illustrative only, and the scope of the present invention is not limited thereto.

### EXAMPLES 1 TO 3 AND COMPARATIVE EXAMPLES 1 TO 4

### Solidifying Compositions

Straight asphalt (AP-3; manufactured by SK Corporation, Korea) or emulsified asphalt (AP-3; manufactured by SK Corporation, Korea) was stored in a separate storage tank at a temperature higher than 130° C. In another storage tank, a mixture containing quantified amounts of an emulsifier for asphalt (Farmin ST-7; Kao Corp., Japan), hydrochloric acid, calcium chloride and water was stored at a temperature of 80° C. The asphalt and the mixture were placed and emulsified in a homogenizer, thus preparing solidifying compositions of Examples and Comparative Examples. Herein, each of the components was added in an amount shown in Table 1 below.

TABLE 1

| | Examples | | | Comparative Examples | | | |
|---|---|---|---|---|---|---|---|
| Components (wt %) | 1 | 2 | 3 | 1 | 2 | 3 | 4 |
| Straight asphalt | 43.3 | 34.0 | 52.0 | 30.0 | 55.0 | 43.3 | — |
| Emulsified asphalt | — | — | — | — | — | — | 43.3 |
| Emulsifier for asphalt | 0.2 | 0.1 | 0.3 | 0.2 | 0.2 | 0.2 | 0.2 |
| Hydrochloric acid | 0.3 | 0.2 | 0.4 | 0.3 | 0.3 | 0.1 | 0.3 |
| Calcium chloride | 0.04 | 0.03 | 0.05 | 0.04 | 0.04 | 0.04 | 0.04 |
| Water | Balance | Balance | Balance | Balance | Balance | Balance | Balance |

### PREPARATION EXAMPLES 1 TO 3 AND COMPARATIVE PREPARATION EXAMPLES 1 TO 4

### Preparation of Cokes

The solidifying compositions prepared according to the components and contents of Table 1 were prepared in advance. Powdery coke was fed into a feed hopper disposed at a conventional equipment line for coke formation and transferred to a storage hopper, in which it was weighed. The powdery coke, the previously prepared solidifying composition, and the aqueous acrylic resin (Hae Han Polymer Ind., Co., Korea), as a reinforcing agent, were mixed with each other in a tube mixer. Then, the mixture was formed into a given shape in a conventional forming machine at a pressure of 20 kg/cm², and the raw material coal was discharged from the machine. Then, the raw material coal was transferred to a stabilization apparatus, in which it was heated at a temperature of 180° C. for 30 minutes, thus producing shaped coke. Herein, each of the components was added in an amount shown in Table 2 below.

TABLE 2

| | | Preparation | | | Comparative Preparation | | | |
|---|---|---|---|---|---|---|---|---|
| | | Examples | | | Examples | | | |
| Components (wt %) | | 1 | 2 | 3 | 1 | 2 | 3 | 4 |
| Solidifying | Example 1 | 6 | — | — | — | — | — | — |
| compositions | Example 2 | — | 6 | — | — | — | — | — |
| | Example 3 | — | — | 6 | — | — | — | — |
| | Comparative | — | — | — | 6 | — | — | — |
| | Example 1 | | | | | | | |
| | Comparative | — | — | — | — | 6 | — | — |
| | Example 2 | | | | | | | |
| | Comparative | — | — | — | — | — | 6 | — |
| | Example 3 | | | | | | | |
| | Comparative | — | — | — | — | — | — | 6 |
| | Example 4 | | | | | | | |
| Reinforcing agent | Aqueous acrylic | 0.15 | 0.15 | 0.15 | 0.15 | 0.15 | 0.15 | 0.15 |
| | resin | | | | | | | |
| Solid fossil fuel | Powdery coke | 100 | 100 | 100 | 100 | 100 | 100 | 100 |
| | (POSCO Co., | | | | | | | |
| | Korea) | | | | | | | |

### TEST EXAMPLE 1

### Measurement of Coke Quality

The coke prepared in Examples 1 to 3 and Comparative Examples 1 to 4 was measured for initial weight moisture (IM), volatile matter (VM; dry basis), ash and fixed carbon (FC) contents, compressive strength, porosity and heating value according to conventional methods, and the measurement results are shown in Table 3 below.

TABLE 3

| | | Preparation | | | Comparative Preparation | | | |
|---|---|---|---|---|---|---|---|---|
| | | Examples | | | Examples | | | |
| Quality | | 1 | 2 | 3 | 1 | 2 | 3 | 4 |
| Main | Moisture | 0.36 | 0.39 | 0.37 | 0.41 | 0.37 | 0.39 | 0.42 |
| components | Volatile | 1.76 | 2.50 | 1.61 | 1.37 | 1.98 | 1.18 | 1.84 |
| (wt %) | matter | | | | | | | |
| | Ash | 11.82 | 9.77 | 11.78 | 12.80 | 11.53 | 12.18 | 11.30 |
| | Fixed carbon | 86.06 | 87.34 | 86.24 | 85.42 | 86.12 | 86.25 | 86.44 |
| Performance | Compressive | 77.2 | 75.3 | 72.5 | 42.3 | 28.5 | 53.3 | 29.5 |
| | strength | | | | | | | |
| | (kg/cm²) | | | | | | | |
| | Porosity (%) | 34 | 35 | 32 | 32 | 35 | 32 | 34 |
| | Heating | 6,894 | 6,834 | 6,899 | 6,204 | 6,566 | 6,329 | 7,588 |
| | value | | | | | | | |
| | (kcal/kg) | | | | | | | |

Coke prepared according to the conventional furnace process using coking coal as a raw material contains 0.5-2.0 wt % of volatile matter, 10-13 wt % of ash and 80-89 wt % of fixed carbon, and has a heating value of 6,500-7,200 kcal/kg, a compressive strength of 50-60 kgf/cm² and a porosity of 30-45%. In comparison with this, the contents of main components of the coke prepared in Preparation Examples 1-3 by adding the inventive solidifying composition to powdery coke, as a raw material, were similar to those of the prior coke, and the heating values thereof were also similar to that of the prior coke. Meanwhile, in the case of the coke prepared in Comparative Preparation Example 1 by adding a small amount of straight asphalt, the compressive strength did not reach 50 kgf/cm², and the heating value was about 6,200 kcal/kg, which is lower than that of the coke prepared according to the conventional furnace process. In the case of the coke prepared in Comparative Preparation Example 2 by adding an excess amount of straight asphalt, the compressive strength was further reduced to less than 30 kgf/cm², and in the case of the coke prepared in Comparative Preparation Example 3 by adding a small amount of hydrochloric acid, the heating value was just higher than 6,300 kcal/kg. Meanwhile, the coke of Comparative Preparation Example 4, containing emulsified asphalt instead of straight asphalt, had a very high heating value, but showed a very low compressive strength of less than 30 kgf/cm².

### EXAMPLES 4 TO 8

### Preparation of Coke

According to the components and contents shown in Table 4 below, a solidifying composition, a reinforcing agent and a single solid fossil fuel or mixture thereof were uniformly mixed with each other in the same manner as in Preparation Examples 1-3, thus producing coke. In Preparation Example 8, cement (manufactured by Tong Yang Cement Corp, Korea) was added along with other components in the mixing step.

TABLE 4

| Components | | Preparation Examples | | | | |
|---|---|---|---|---|---|---|
| (parts by weight) | | 4 | 5 | 6 | 7 | 8 |
| Solidifying | Example 1 | 6 | 6 | 6 | 6 | 6 |
| composition | | | | | | |
| Reinforcing | Aqueous | 0.15 | 0.15 | 0.15 | 0.15 | 0.15 |
| agent | acrylic resin | | | | | |
| Cement | Portland | — | — | — | — | 2 |
| | cement | | | | | |
| Solid fossil | Powdery coke | 50 | 50 | — | — | — |
| fuels | Anthracite | 50 | — | 50 | 100 | — |
| | coal | | | | | |
| | Bituminous | — | 50 | 50 | — | 100 |
| | coal | | | | | |

### TEST EXAMPLE 2

### Measurement of Coke Quality

The main component contents and heating values of the cokes prepared in Preparation Examples 4-8 were measured, and the measurement results are shown in Table 5 below.

TABLE 5

| | | Preparation Examples | | | | |
|---|---|---|---|---|---|---|
| Quality | | 4 | 5 | 6 | 7 | 8 |
| Main | Moisture | 1.19 | 2.18 | 2.19 | 3.34 | 2.13 |
| components | Volatile | 3.56 | 17.37 | 15.00 | 7.60 | 16.11 |
| (wt %) | matter | | | | | |
| | Ash | 13.93 | 3.15 | 9.43 | 10.83 | 16.92 |
| | Fixed carbon | 81.32 | 77.30 | 73.38 | 78.23 | 64.84 |
| Performance | Heating value | 6,528 | 7,085 | 6,950 | 6,260 | 7,492 |
| | (kcal/kg) | | | | | |

The coke prepared in Preparation Example 8 using only bituminous coal as a raw material and having the inventive solidifying composition added thereto had the highest heating value. In addition, the cokes prepared in Preparation Examples 5 and 6 using either powdery coke or a mixture of anthracite coal and bituminous coal as a raw material, and the coke prepared in Preparation Example 4, using a mixture of powdery coke and anthracite coal without using bituminous coal, also showed an excellent heating value of more than 6,500 kcal/kg. Meanwhile, the coke prepared in Preparation Example 7, using only anthracite coal as a raw material, had a heating value of more than 6,200 kcal/kg, which is a greatly increased value in view of the fact that the heating value of anthracite coal is generally in the range of 4,500-5,800 kcal/kg.

### TEST EXAMPLE 3

### High-Temperature Stability Test of Coke

Each of a sample coal formed from the coke of Preparation Example 6, and a sample coal (manufactured by POSCO Co.) formed from the coke produced in an existing coke process, was adjusted to a temperature of 1,152° C. in a conventional high-temperature stability test apparatus. Then, the state of coke was observed after 1 hour and 30 min, after 30 minutes at 1152° C. and after 30 minutes at 770° C. As a result, the sample coal according to the existing process was observed to be severely deformed, whereas the sample coal prepared by adding the inventive solidifying composition was not observed to be deformed, even at high temperatures.

### TEST EXAMPLE 4

### Durability Test of Coke

The shaped coke material of Preparation Example 1 was placed in a conventional electric furnace, in which the external behavior of the coke was observed at temperatures of 1,000° C. and 1,200° C. As a result, the coke prepared in Preparation Example 1 by adding the inventive solidifying composition maintained the original structure thereof, even at a high temperature of 1200° C., without showing product degradation phenomena, such as fractures or cracks. Thus, it can be expected that there would be no behavior preventing aeration in the furnace due to degradation.

Mixed shaped coal, which is prepared by mixing two or more solid fossil fuels with each other, can be produced as a custom product satisfying various demands of consumers by adjusting the heating value and combustion time, and can be formed into various shapes. Because the strength of the product can be controlled freely in the range of 30-80 kg/cm², the quality of the product can be controlled according to the demands of consumers. Also, the size of the product can be set in the range of 25-200 mm, and the product can also be prepared to have various shapes.

The solidifying composition according to the present invention can be widely used in iron mills, steel works, steam power plants, cogeneration power plants, cement manufacturers' kilns, glass manufacturing plants, nonferrous metal manufacturing plants, iron foundries, tire factories, fuel for controlled agriculture, home fuel, incineration plants and the like.

As is apparent from the foregoing, the solidifying composition according to the present invention can contain straight asphalt produced in Korea, without any additional processing, and can rapidly solidify any kind of solid fossil fuel regardless of the moisture content of solid fossil fuels, including powdery coke and bituminous coal.

Also, the composition is a liquid emulsion containing water, in which hardly any separation between the components occurs. Moreover, it is easily uniformly mixed with solid fossil fuels in the preparation of solidified materials, so that the strength variation of the products is very low, making processing and quality control easier. Furthermore, since the liquid phase of the composition is almost burned out in a curing process during the production of products, the produced solidified material does not increase the amount of ash even when it is used as fuel and as a reducing agent. Thus, it will generate little or no additional slag in steel manufacturing operations.

In addition, when the inventive solidifying composition is used, a coke process can utilize an existing factory or a simple factory constructed without complicated unnecessary facilities.

Although the preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A composition for solidifying solid fossil fuel, containing 34-52 wt % of straight asphalt, 0.1-0.3 wt % of an emulsifier for asphalt, 0.2-0.4 wt % of hydrochloric acid, 0.03-0.05 wt % of calcium chloride, and the balance of water.

2. The composition of claim 1, wherein the solid fossil fuel is coal or coal-based fuel.

3. The composition of claim 2, wherein the solid fossil fuel is powdery coke, bituminous coal, anthracite coal, or a mixture of two or more thereof.
